(19) United States
(12) Patent Application Publication
(10) Pub. No.: US 2014/0087217 A1
(43) Pub. Date: Mar. 27, 2014

(54) BATTERY CELL HAVING A CLICK SPRING AREA INTEGRATED INTO THE HOUSING COER PLATE

(71) Applicants: Mathias ZINK, Gundelsheim (DE); Thomas RAHN, Stuttgart (DE); Markus FEIGL, Markgroeningen (DE)

(72) Inventors: Mathias ZINK, Gundelsheim (DE); Thomas RAHN, Stuttgart (DE); Markus FEIGL, Markgroeningen (DE)

(73) Assignee: Robert Bosch GmbH, Stuttgart (DE)

(21) Appl. No.: 14/034,873

(22) Filed: Sep. 24, 2013

(30) Foreign Application Priority Data
Sep. 26, 2012 (DE) 10 2012 217 451.6

(51) Int. Cl. H01M 2/34; H01M 2/02; H01M 10/0525

(52) U.S. Cl. CPC H01M 2/345; H01M 10/0525; H01M 2/0237
USPC 429/61; 29/623.1

(57) ABSTRACT

A battery (e.g., lithium-ion) cell having fewer components than conventional cells. A metallic housing, having a winding element, two current collectors, and an electrolyte, is closed off in a gas- and pressure-tight manner with a cover assembly having a cover plate by which a housing opening is largely closed off. A click spring area (formable in this plate) has a smaller thickness than surrounding areas of the plate, and can snap from a first state, in which the click spring area is bent inwardly into the housing, into a second state in which the click spring area is bent outwardly from the housing when a threshold internal pressure in the housing is exceeded, and establishes an electrical connection between the plate and a current collector. When there is a pressure rise in the housing due to temperature, for example, the battery cell may be deactivated in a targeted manner.

### RELATED APPLICATION INFORMATION

The present application claims priority to and the benefit of German patent application no. 10 2012 217 451.6, which was filed in Germany on Sep. 26, 2012, the disclosure of which is incorporated herein by reference.

### FIELD OF THE INVENTION

The present invention relates to a battery cell, in particular a lithium-ion battery cell. Moreover, the present invention relates to a motor vehicle having such a battery cell.

### BACKGROUND INFORMATION

Battery cells, sometimes also referred to as accumulator cells, are used for chemically storing electrically provided energy. Battery cells are presently already being used for supplying power to a variety of mobile devices. In the future, battery cells will be used, among other things, for supplying power to mobile electric vehicles or hybrid vehicles for use on land or in water, or for stationary temporary storage of electrical energy originating from alternative energy sources.

To this end, a plurality of battery cells is usually assembled into battery packs. In order to utilize an available packet volume in the most efficient manner possible, battery cells having a prismatic, for example cuboidal, shape are primarily used for this purpose.

Due to their potential high energy density, thermal stability, and absence of a memory effect, for demanding applications such as storage approaches for motor vehicles, for example, a lithium-ion accumulator technology is usually used, which on account of the great economic importance of electromobility in the future is presently undergoing further intensive development.

Many different types of battery cells, in particular lithium-ion battery cells, as well as in particular battery cells having a prismatic shape, already exist. However, such conventional battery cells usually have a complex configuration in which a large number of different individual parts are used for assembly of the entire battery cell. Such a large number of individual parts having various shapes, functions, and composed of different materials requires the use of a variety of manufacturing technologies and equipment. In addition, the large number of different individual parts must always be available in their entirety for the manufacture of the battery cell, which requires coordination of the production of the individual components as well as an appropriate inventory. All of these factors may contribute to increased costs in the manufacture of the battery cell.

### SUMMARY OF THE INVENTION

With the aid of specific embodiments of the present invention, among other things the number of individual components necessary for assembling a battery cell may be reduced, and/or assembly of a battery cell may be simplified.

A battery cell, in particular a lithium-ion battery cell, is proposed which has a winding element, an electrolyte, two current collectors, and a housing. The winding element is composed of a wound stack made of a first foil, for example made of copper, coated with anode material, a second foil, for example made of aluminum, coated with cathode material, and two plastic films which are used as diaphragms. One of the current collectors is connected, for example welded, to the first foil of the winding element in an electrically conductive manner. The second current collector is connected to the second foil of the winding element in an electrically conductive manner. The housing has a metallic container and a metallic cover assembly. The container has an opening through which the winding element and the two current collectors may be introduced into the housing during manufacture of the battery cell. The cover assembly is configured to close off the opening in the container in a gas-tight and pressure-tight manner. For this purpose, the cover assembly has, among other elements, a cover plate which may largely close off the opening in the container and which may be connected to the container, for example via a weld seam, for hermetically sealing the housing.

A leadthrough arrangement is provided on the cover assembly in order to lead out electrically conductive contact arrangements, which in each case are in contact with one of the current collectors inside the housing, from the housing and through the cover assembly. The proposed battery cell is characterized in that the cover plate has a click spring area of reduced thickness which is configured to snap from a first state, in which the click spring area is bent inwardly into the housing, into a second state in which the click spring area is bent outwardly from the housing when a threshold internal pressure in the housing is exceeded, and to thus establish an electrical connection between the cover plate and one of the current collectors.

Specific embodiments of the battery cell according to the present invention are based, among other factors, on the following concepts and findings:

In battery cells, the winding element, having its stack composed of different metal foils and diaphragms situated in between together with the electrolyte which wets this stack, is used for the chemical storage of energy, whereby the chemically stored energy may be provided in the form of electrical energy by suitable chemical reactions at the electrodes.

Due to, for example, a strong temperature rise (“thermal runaway”) in the battery cell, which may occur, for example, during a very large power withdrawal or with very high charging currents, a pressure rise may result within the housing of the battery cell. To avoid a hazardous overpressure in the battery cell which could endanger the integrity of the battery cell as well as its surroundings, a safeguard may be provided on the housing which may act as a type of emergency stop switch, and which deactivates the battery cell by producing a short circuit when there is an excess internal pressure in the housing.

Whereas in conventional battery cells, an emergency stop switch system is usually implemented with the aid of additional, separate components such as a separate so-called overcharge safety device (OSD) membrane, which must be welded to the cover plate, it is now proposed to implement such functionality by a specific configuration of the cover plate, which is provided anyway in the cover assembly of the battery cell. This cover plate, which except for several small openings provided for certain purposes completely closes off the large opening provided on the container of the battery housing and is connected to the container with a hermetic seal, is configured with a click spring area which is able to change its shape due to a locally reduced material thickness at that location when there is an increased internal pressure in the housing. During normal operation of the battery cell, i.e., when the internal pressure in the housing of the battery cell is below a threshold value, the click spring area should to be bent inwardly.

In other words, the click spring area should normally be concave, viewed from outside the housing. Similarly as for the “clickers” known as a toy, the click spring area is configured to abruptly change its shape and snap from the inwardly bent, concave first state into an outwardly bent, convex second state when a threshold internal pressure, which may assume a value in the range of 2,500 hPa to 4,500 hPa, for example, is exceeded. In this second state, the click spring area may come into contact, for example, with a contact element situated adjacent to the cover plate. When this contact element is electrically connected to one of the current collectors, an electrical connection between the cover plate and this current collector may thus be closed. Since the cover plate itself is generally in electrical connection with the other current collector, when the click spring area snaps into the second state it may thus short-circuit the battery cell, thus avoiding a further temperature or pressure rise in the battery cell.

The click spring area is preferably integrated as one piece into the cover plate. In other words, the cover plate together with the click spring area forms a single component, so that maintaining and installing separate components, for example a separate OSD membrane, may be dispensed with.

To be able to manufacture the cover plate, which is to be provided for the battery housing, in one piece with the click spring area to be integrated therein, appropriately suited manufacturing processes may be used. For example, the click spring area of reduced thickness may be formed by embossing in the cover plate, i.e., with the aid of pressure forming of a metal sheet which forms the cover plate. In particular, a metal sheet which forms the cover plate may be embossed in such a way that the click spring area results. During embossing, material from the click spring area to be formed may be displaced by pressing into adjoining areas of the cover plate, so that a thickened area results in the cover plate around the completed click spring area, the material thickness of the thickened area being greater than an average thickness of the cover plate outside this click spring area.

In other words, during manufacture of the cover plate, in addition to any necessary punching and bending operations, an embossing operation may also be carried out in which no material is ultimately removed from the cover plate, but, rather, material is only displaced from one area, which is to subsequently form the click spring area, to adjoining areas. Due to such a material displacement, the material thickness in the click spring area is significantly reduced, for example to less than one-half, preferably less than one-third, of the thickness of the metal sheet which forms the cover plate, while the thickness of the cover plate is locally increased in the adjoining thickened areas. For example, the cover plate may have an average thickness of greater than 0.8 mm, preferably greater than 1.5 mm, while the click spring area may only have a thickness of less than 0.3 mm, preferably less than 0.2 mm. The click spring area, in contrast to the relatively rigid, stable cover plate, may thus acquire a reduced strength, similarly to a thin foil. During the embossing process, the click spring area may at the same time be formed into an inwardly bent shape. For example, the click spring area may be embossed as a circular, concavely inwardly bent area having an inwardly directed spherical surface, for example.

The described possible features of the battery cell and configurations of the components of the battery cell, in particular the integrated configuration of a click spring area, which acts similarly to an OSD membrane, in the cover plate of the housing of the battery cell, are particularly suited for use in battery cells having a housing with a prismatic shape.

The cover plate which is provided with the integrated click spring area may result in multiple advantages in the manufacture of the battery cell as well as for the completed battery cell. For example, during manufacture of the battery cell, the installation of an additional emergency stop switch system, for example welding-in of an additional OSD membrane provided as a separate metallic component, may be dispensed with. In particular, in this regard conventionally used welding processes may be dispensed with. In addition, defects which may result during such welding processes may be avoided. The manufacturing process may be provided with a simpler and more favorable configuration due to the overall possible savings on components.

It is pointed out that possible features and advantages of a battery cell according to the present invention are described herein with reference to various specific embodiments. Those skilled in the art are aware that the individual features may be suitably combined or exchanged with one another in order to obtain further specific embodiments and possible synergy effects.

Specific embodiments of the present invention are described below with reference to the appended drawings; neither the description nor the drawings are to be construed as limiting the present invention.

The figures are merely schematic and not to scale. Identical or functionally equivalent features are denoted by the same reference numerals in the figures.

### BRIEF DESCRIPTION OF THE DRAWINGS

FIG. 1 shows an exploded drawing of a lithium-ion battery cell.

FIG. 2 shows a perspective view of a cover plate for a battery cell according to one specific embodiment of the present invention.

FIG. 3 shows a perspective partial view of a cut away cover plate for a battery cell along line B-B shown in FIG. 2, according to one specific embodiment of the present invention.

FIG. 4 shows a cross-sectional view of a cover plate in a cover assembly for a battery cell along line A-A shown in FIG. 2, according to one specific embodiment of the present invention.

FIG. 5 shows a motor vehicle having a battery according to one specific embodiment of the present invention.

### DETAILED DESCRIPTION

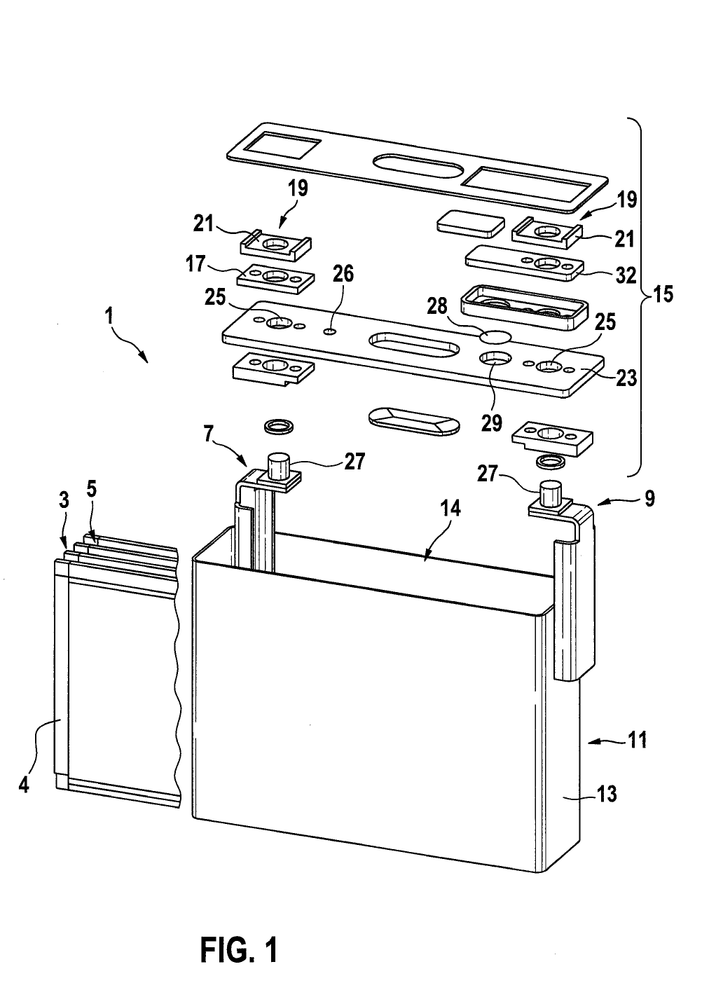

FIG. 1 shows a conventional lithium-ion battery cell in an exploded view. It is apparent that the battery cell is composed of a plurality of individual components which are separately maintained in inventory and which must be put together in a complex procedure during manufacture. Only the components and their features necessary for the understanding of specific embodiments of the present invention are described herein; a description of the remaining components of the battery cell is dispensed with.

Battery cell 1 has a winding element 3 having a wound stack 5 made of copper foil and coated with anode material, and an aluminum foil which is coated with cathode material, as well as plastic films situated in between which are used as diaphragms.

For the electrical contacting, the copper foil and the aluminum foil are stacked along the winding axis, slightly offset in the opposite direction one above the other, so that the copper foil on a narrow side, and the aluminum foil on an opposite narrow side, each protrude slightly beyond a respective edge of the winding element. A current collector 7 made of copper is welded to a protruding area 4 of the copper foil, so that this current collector is electrically connected to the anode of the winding element. A second current collector 9 made of aluminum is welded to an opposite protruding area of the aluminum foil in order to establish an electrical contact with the cathode of winding element 3.

Winding element 3 provided with the two current collectors 7, 9 is then introduced through an opening 14 into a cuboidal container 13 which is open at the top. Opening 14 is subsequently closed off by a cover assembly 15. A liquid electrolyte is then filled into container 13 through a small opening 26 in a cover plate 23 which is subsequently closable, and thus comes into contact with the anode and cathode materials provided on the metal foils of the winding element, so that at the interfaces, desired chemical reactions may take place between these materials and the electrolyte and may correspondingly result in the conversion of chemical energy into electrical energy, and vice versa. Container 13 is made of sheet metal so that, among other things, it is able to withstand the chemically aggressive electrolyte.

Cover assembly 15 is composed of a plurality of components. The components are necessary for implementing multiple different functions for entire battery cell 1 with the aid of cover assembly 15. For example, with the aid of cover assembly 15, not only should container 13 be closed in a gas-tight and pressure-tight manner, but also contact arrangements 19 should allow a connection between the interior of container 13 and the external surroundings, thus allowing an electrical connection between each of the current collectors 7, 9, on the one hand, and contact elements 21 to be contacted from the outside, on the other hand.

For this purpose, cover assembly 15 has, among other elements, a cover plate 23 which at its side edges may be tightly connected, for example by welding, to one edge of opening 14 in container 13. To be able to withstand the electrolyte to be accommodated inside container 13, this cover plate 23 is usually composed of a metal. Multiple openings are provided in cover plate 23 which are used for various tasks.

For example, openings 25 are provided through which integral parts of contact arrangements 19, such as a journal 27 mounted on a current collector 7, 9, may extend.

Furthermore, an opening 26 is provided through which electrolyte may be filled into the interior of housing 11 after container 13 has been closed off by cover plate 23.

In addition, further components such as a potential plate 17 are provided in order to electrically connect one of contact arrangements 19 to cover plate 23, and thus to set cover plate 23 as well as container 13 connected thereto at the same electrical potential as current collector 7, 9, which is connected to this contact arrangement 19.

Cover plate 23 also has an additional circular opening 29. This opening 29 is closed off by an OSD membrane 28 configured as a separate component. The OSD membrane is a component in the form of a thin, curved metal foil which is welded at its edge to cover plate 23 in an area around opening 29. OSD membrane 28 is configured to snap outwardly when there is an overpressure within housing 11 caused by a temperature rise, for example, and in the process to establish contact with connecting plate 32 situated thereabove. Since this connecting plate 32 is electrically connected to the other current collector 9, this results in a short circuit of the battery cell, and the battery cell is deactivated.

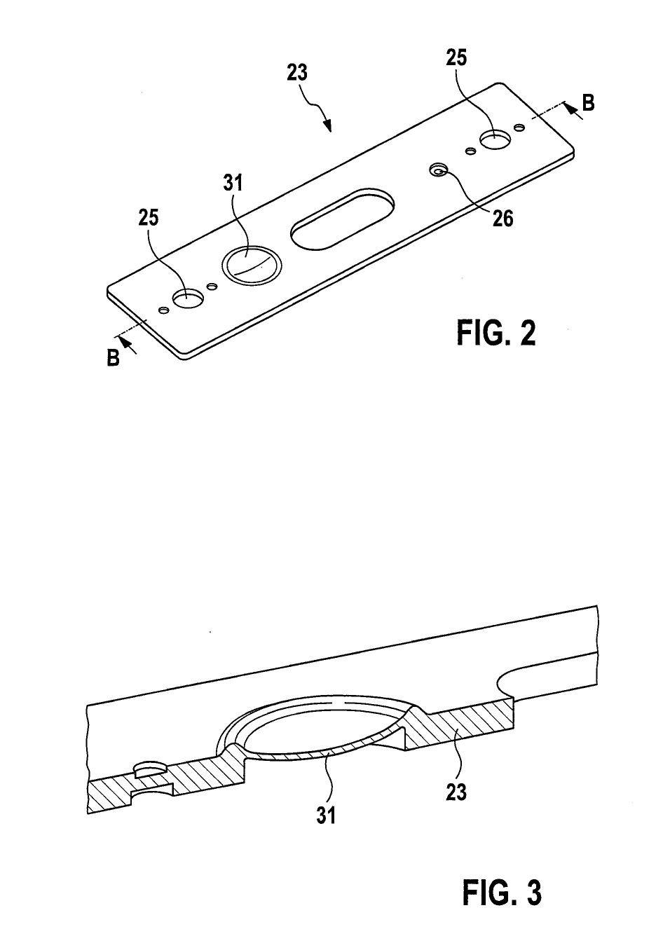

FIG. 2 shows a modified cover plate 23 for a battery cell according to one specific embodiment of the present invention. Cover plate 23, in addition to openings 25 for leading through contact arrangements 19, and opening 26 for filling the electrolyte, has a click spring area 31. The entire cover plate 23, including click spring area 31, is formed from a metal sheet. Click spring area 31 is produced by displacing material from this area into adjoining areas with the aid of an embossing process, so that click spring area 31 has a reduced thickness compared to an average thickness of cover plate 23.

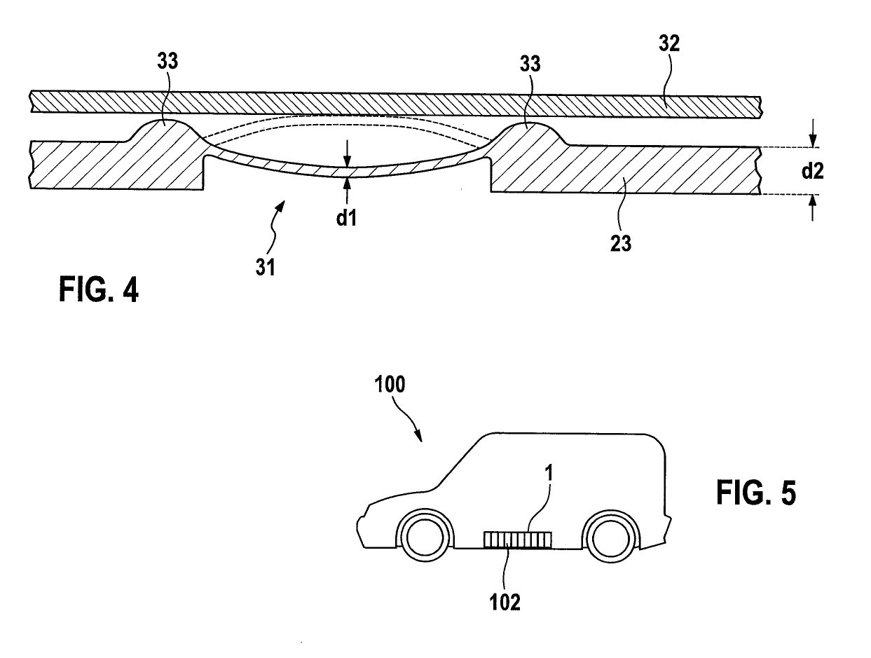

As illustrated, for example, in the partially cut away perspective view in FIG. 3 along line B-B from FIG. 2, and in the cross-sectional view in FIG. 4 along line A-A from FIG. 2, click spring area 31 has a significantly smaller thickness d1 than thickness d2 of the sheet metal forming cover plate 23. Thickness d1 of click spring area 31 may be selected, for example, as a function of the material properties and the geometric configuration of the click spring area in such a way that the click spring area locally snaps from the concavely inwardly curved first state shown in the figures into a convexly outwardly curved second state shown in dashed lines in FIG. 4 when there is an increased internal pressure in housing 11 of, for example, greater than 3,500 hPa. In this second state, the click spring area comes into contact, for example, with a connecting plate 32 situated just above same, and via this connecting plate closes an electrical circuit toward current collector 9, thereby short-circuiting and thus deactivating battery cell 1. For example, thickness d2 of the sheet metal used for cover plate 23 may typically be between 0.8 mm and 3 mm, while thickness d1 of the click spring area for achieving the desired snap properties may be reduced to less than 0.3 mm.

To produce cover plate 23 as one piece with click spring area 31 which is integrally formed therein, for example a punch of suitable geometry may be impressed into the metal sheet forming cover plate 23. The shape of this punch is configured in such a way that material is displaced from the center of the area to be embossed and transferred into adjoining areas. Thickened areas 33 may thus result at the edge around click spring area 31, at which cover plate 23 has a greater thickness than original thickness d2 of the metal sheet used. Depending on the type and shape of the punch used, thickened areas 33 may have a thickness that is increased by 0.5 mm to 3 mm, for example.

The process of embossing the metal sheet for producing click spring area 31 in cover plate 23 may also be carried out in a single embossing process and/or using a single embossing tool; however, multiple separate embossing processes, for example using different embossing tools or punches, may be used to ultimately produce the desired concave shape and geometry for click spring area 31.

FIG. 4 shows a motor vehicle 100 having a battery 102 composed of multiple battery cells 1 described above.

What is claimed is:

1. A battery cell, comprising:
a winding element composed of a wound stack made of a first foil coated with anode material, a second foil coated with cathode material, and two plastic films which are used as diaphragms;
an electrolyte;
two current collectors, one of which is connected to the first foil, and one of which is connected to the second foil, in an electrically conductive manner;
a housing having a metallic container and a metallic cover assembly;
wherein the metallic container has an opening through which the winding element and the two current collectors are introduceable into the housing during manufacture of the battery cell,
wherein the metallic cover assembly has a cover plate which closes off the opening in the metallic container in a gas-tight and pressure-tight manner, a leadthrough arrangement being provided on the cover assembly for leading electrically conductive contact arrangements in a gas-tight manner, which are in contact with each of the current collectors inside the housing, through the cover plate out of the housing, and
wherein the cover plate has a click spring area of reduced thickness which is configured to snap from a first state, in which the click spring area is bent inwardly into the housing, into a second state in which the click spring area is bent outwardly from the housing when a threshold internal pressure in the housing is exceeded, and to thus establish an electrical connection between the cover plate and one of the current collectors.

2. The battery cell of claim 1, wherein the cover plate has a thickened area around the click spring area which has a thickness that is greater than an average thickness of the cover plate outside the click spring area.

3. The battery cell of claim 1, wherein the cover plate has an average thickness of greater than 0.8 mm, and the click spring area has a thickness of less than 0.3 mm.

4. The battery cell of claim 1, wherein the click spring area is configured to snap into the second state when a threshold internal pressure of 3,500 hPa±1,000 hPa in the housing is exceeded.

5. The battery cell of claim 1, wherein the cover plate including the click spring area is manufactured by embossing a metal sheet.

6. The battery cell of claim 1, wherein the click spring area is integrated as one piece into the cover plate.

7. A method for manufacturing a housing for a battery cell, having a metallic container and a metallic cover assembly, the method comprising:
introducing into an opening of the metallic container a winding element, two current collectors, and an electrolyte during manufacture of the battery cell;
providing a cover plate for the cover assembly which closes off the opening in the metallic container in a gas-tight and pressure-tight manner after the housing is finished;
forming a click spring area of reduced thickness in the cover plate by embossing, the click spring area being configured to snap from a first state, in which the click spring area is bent inwardly into the housing, into a second state in which the click spring area is bent outwardly from the housing when a threshold internal pressure in the housing is exceeded.

8. The method of claim 7, wherein during embossing, material from the click spring area is displaced by pressing into an adjoining thickened area of the cover plate.

9. A motor vehicle, comprising:
a battery cell, including:
a winding element composed of a wound stack made of a first foil coated with anode material, a second foil coated with cathode material, and two plastic films which are used as diaphragms;
an electrolyte;
two current collectors, one of which is connected to the first foil, and one of which is connected to the second foil, in an electrically conductive manner;
a housing having a metallic container and a metallic cover assembly;
wherein the metallic container has an opening through which the winding element and the two current collectors are introduceable into the housing during manufacture of the battery cell,
wherein the metallic cover assembly has a cover plate which closes off the opening in the metallic container in a gas-tight and pressure-tight manner, a leadthrough arrangement being provided on the cover assembly for leading electrically conductive contact arrangements in a gas-tight manner, which are in contact with each of the current collectors inside the housing, through the cover plate out of the housing, and
wherein the cover plate has a click spring area of reduced thickness which is configured to snap from a first state, in which the click spring area is bent inwardly into the housing, into a second state in which the click spring area is bent outwardly from the housing when a threshold internal pressure in the housing is exceeded, and to thus establish an electrical connection between the cover plate and one of the current collectors.

10. The battery cell of claim 1, wherein the battery cell includes a lithium-ion battery cell
